(19) United States
(12) Patent Application Publication
(10) Pub. No.: US 2005/0103415 A1
(43) Pub. Date: May 19, 2005

(54) Tire with shock absorbing closed cell rubber tread of spaced apart lugs

(76) Inventors: Lewis Timothy Lukich, Akron, OH (US); Paul Harry Sandstrom, Cuyahoga Falls, OH (US); Kristine Nicole Ludwig, Dublin, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/716,059

(22) Filed: Nov. 18, 2003

(51) Int. Cl. B60C 11/11; B60C 17/02; B60C 11/00; B60C 1/00

(52) U.S. Cl. 152/209.12; 152/209.1

(57) ABSTRACT

The invention relates to a pneumatic rubber tire having an outer, circumferential tread wherein said tread has a tread configuration comprised of significantly spaced apart, raised lugs designed to be shock absorbingly ground engaging. For such tire, it is intended that, in the field, normally few tread lugs actually engage the ground at any one time in a manner that individual lugs have a relatively significant shock absorbing responsibility. Said tread and associated tread lugs are comprised of a shock dampening closed cellular rubber composition. The rubber for such cellular rubber composition for said tread of spaced apart lugs is comprised of conjugated diene-based elastomers or comprised of elastomers selected from butyl rubber, halogenated butyl rubber or brominated copolymer of isobutylene and paramethylstyrene rubber. Said butyl rubber is a copolymer of isobutylene and a minor amount of a diene monomer such as isoprene. Preferably the rubber for the cellular tread rubber composition is an isobutylene copolymer. Thus, such tread is a combination of structural configuration of spaced apart lugs together with a closed cellular rubber composition of selected elastomer(s) to create a shock absorbing effect for the tire tread lugs.

### FIELD OF THE INVENTION

The invention relates to a pneumatic rubber tire having an outer, circumferential tread wherein said tread has a tread configuration comprised of significantly spaced apart, raised lugs designed to be shock absorbingly ground engaging. For such tire, it is intended that, in the field, normally few tread lugs actually engage the ground at any one time in a manner that individual lugs have a relatively significant shock absorbing responsibility. Said tread and associated tread lugs are comprised of a shock dampening closed cellular rubber composition. The rubber for such cellular rubber composition for said tread of spaced apart lugs is comprised of conjugated diene-based elastomers or comprised of elastomers selected from butyl rubber, halogenated butyl rubber or brominated copolymer of isobutylene and paramethylstyrene rubber. Said butyl rubber is a copolymer of isobutylene and a minor amount of a diene monomer such as isoprene. Preferably the rubber for the cellular tread rubber composition is an isobutylene copolymer. Thus, such tread is a combination of structural configuration of spaced apart lugs together with a closed cellular rubber composition of selected elastomer(s) to create a shock absorbing effect for the tire tread lugs.

### BACKGROUND OF THE INVENTION

Tires used for vehicles intended to be used for off-the-road service such as, for example, farm tractors and various off-the-road vehicles, typically have tires with treads which contain significantly spaced apart lugs.

In particular, the running surface of such tire tread is of a configuration of widely spaced apart lugs to provide a ratio of net running surface of the tread lugs to the tread's gross dimensions (net to gross ratio expressed in terms of percentage of the running surface of the tread lugs) which may be in a range of from about 15 percent to 22 percent.

Therefore, operationally in the field, normally few tread lugs actually engage the ground at any one time. Such individual tread lugs may typically experience relatively high loads as they engage the ground and are desirably sufficiently resilient to absorb significant shocks to retard a tire's tendency to bounce or hop, particularly where such tire is positioned on a drive wheel of the vehicle, as the lugs engage the ground upon torque being applied to the tire through the vehicular axle and wheel. Such vehicular tire's tendency to bounce or hop upon application of relatively high torque to the ground engaging tread lugs is well known to those having skill in such art, particularly in the case of driven tractor tires.

Vehicular drive tires for this invention are tires intended for service involving soil engaging operations and such tires which are configured with significantly spaced apart lug projections so that the tread of the tire of the driven tractor wheel may act somewhat as a gear to engage the soil and thereby propel the tractor itself across the ground.

The spaced apart tread lugs of such vehicular tire, particularly a farm tractor tire, which have relatively few lugs actually contacting the soil at any one time, may be expected to have significant and individual responsibilities for engaging the soil and propelling the vehicle itself across a field amidst uneven ground which may include crop stubble.

Because the population of the running surface of the tread lugs itself is relatively small, their shock adsorbing, or dampening, responsibility is considerable for both in the case of torque being applied to a driven wheel under load upon which such tire is mounted which may promote a hopping effect for the tire and vehicle in which a significant driving power may be lost, and, also, for a passenger's comfort.

Such vehicular tire treads for this invention, because of their widely spaced apart raised ground engaging lugs, have a ratio of net running surface of the tread lugs to the tread's gross dimensions (net to gross ratio expressed in terms of percentage of the running surface of the lugs) in a range of only from about 15 percent to about 22 percent as compared to more conventional passenger tires which may have an net to gross ratio more in a range of from about 50 to about 85 percent because it is normally desired for the passenger tires to present a significantly greater running surface to the road and thereby a smoother ride for the vehicle itself rather than spaced apart, gear-like ground engaging tread lugs.

In practice, the individual tread lugs must be able to accept significant torque being applied under load and be sufficiently resilient under such circumstances to resist a resultant bouncing, or hopping, phenomenon in the field in a manner far different from a tire tread having tread lugs spaced close together where a significant plurality of the closely spaced lugs are expected to be gear-like ground-contacting instead of typical passenger tire treads designed to travel over highways and other relatively hard surfaced roads.

The tire tread lugs, and associated tread, for this invention have a shock absorbing, or dampening, property attributed to a closed cellular rubber composition of various elastomers which may be, for example, at least one conjugated diene rubber or may be composed of isobutylene copolymer based rubber(s). For example, the tread lugs may be comprised of a rubber having a shock dampening property comprised of an isobutylene based rubber as butyl rubber, halogenated butyl rubber or copolymer of isobutylene and paramethylstyrene which itself has a shock absorbing quality as compared to typical diene-based elastomers. For this invention, the shock absorbing quality of such elastomer(s) is enhanced by providing the associated rubber composition in a form of a closed cellular structure or configuration.

Thus, in one aspect of the invention, the shock absorbing, or dampening, property of the spaced apart tread lugs is provided by a combination of a closed cellular rubber composition and, also, being composed of a rubber which may be, for example, selected from the aforesaid isobutylene-based copolymer elastomer(s).

A measure of such vehicular tread, particularly a farm tractor driven tire tread configuration of spaced apart lugs, is its tread's aforesaid net-to-gross ratio in a range of from about 15 percent to about 22 percent, where the gross is the overall tread footprint provided by the tread lug running surface plus the intermediate region between the lugs and where the net represents the outer running surface (ground-contacting portion) of the tread lugs themselves.

It can readily be seen that such vehicular tires, with lugs designed to be ground engaging, represent only a small portion of the tread which normally contacts the ground, at least insofar as the surface of the lugs themselves are concerned as compared to typical passenger tire treads.

Accordingly, such vehicular tires typically rely more on the weight of the associated vehicle (e.g. farm tractor) to provide tire tread traction over the ground than passenger tires.

Also, it can be readily visualized that shocks originating by the tire traveling over irregularities of the ground are readily transmitted to the wheel, and hence to the axle, of the associated vehicle and thereby transmit the associated shock to the vehicle which, in turn, can result in a discomfort to the individual driving the vehicle.

In such circumstance then, such agricultural vehicles typically rely upon the shock absorbency of the raised lug configuration of the tire tread to provide a degree of shock absorbency for the comfort of vehicle operator.

Accordingly, it remains desirable, in many circumstances, to increase the shock absorbency for such vehicles having a tread of such spaced apart, raised lug configuration.

While butyl rubber, as well as closed cell foam rubber of various diene-based elastomers, have heretofore individually been suggested for use in various tire treads, it is considered that the aforesaid combined adaptation by this invention is a significant departure from past practice. For example, see U.S. Pat. Nos. 6,497,261, 6,062,282, 5,063,268, 4,487,892 and 4,480,762; U.S. Publication No. 2003-0089438-A1; Japanese patent publication No. 59-128,001 (abstract); Soviet Union patent publication 1,625,713 (abstract); and Great Britain patent publication 837,849.

In particular, this invention requires a combination of tread configuration with spaced apart significantly raised lugs where only a minor amount of the tread lugs are actually designed to be ground engaging at any one time in combination with a closed cellular shock absorbing rubber composition composed of diene-based or isobutylene copolymer-based elastomer(s). Thus such spaced apart lugs of relatively minimal ground-contacting population are designed to be shock absorbingly ground contacting.

In the description of this invention, terms such as “compounded rubber”, “rubber compound” and “compound”, if used herein, refer to rubber compositions composed of one or more elastomers blended with various ingredients, including curatives such as sulfur and cure accelerators. The terms “elastomer” and “rubber” might be used herein interchangeably. It is believed that all of such terms are well known to those having skill in such art.

A reference to glass transition temperature, or Tg, of an elastomer or elastomer composition, where referred to herein, represents the glass transition temperature(s) of the respective elastomer or elastomer composition in its uncured state or possibly a cured state in a case of an elastomer composition. A Tg can be suitably determined by a differential scanning calorimeter (DSC) at a temperature rate of increase of 10° C. per minute.

### DISCLOSURE AND PRACTICE OF THE INVENTION

In accordance with this invention, a pneumatic rubber tire is provided, particularly a tire intended for off-the-road service such as for example a farm tractor tire, having a circumferential rubber tread configured with spaced apart raised lugs designed to be shock absorbingly ground contacting, a supporting carcass underlying said tread, a pair of spaced apart beads, and rubber sidewalls extending radially outward from said beads to the peripheral edges of said tread, wherein said raised lugs have an average height of their surface intended to be ground contacting from the base of the lugs on the tire tread in a range of about 12.5 cm to about 80 cm;
wherein said tread is a closed cellular structured rubber composition comprised of, based on parts by weight per 100 parts by weight rubber (phr):
(A) at least one diene-based elastomer, or
(B) an isobutylene copolymer based elastomer, or
(C) an elastomer composition comprised of
   (1) about 75 to about 90, phr of at least one isobutylene copolymer based rubber, and
   (2) about 10 to about 25, phr of at least one diene-based elastomer selected from polymers of isoprene and/or 1,3-butadiene and copolymers of styrene with isoprene and/or 1,3-butadiene;
wherein said isobutylene copolymer elastomer is selected from:
(A) butyl rubber as a copolymer of isobutylene and isoprene containing from about 0.5 to about 6 weight percent units derived from isoprene,
(B) halobutyl rubber as a halogenated butyl rubber where the halogen is selected from bromine or chlorine, preferably bromine, or
(C) brominated copolymer of isobutylene and paramethylstyrene.

In practice, preferably the running surface of the tread lugs to the tread's gross dimensions (net to gross ratio expressed in terms of percentage of the running surface of the lugs as compared to the tread's overall tread lug running surface plus the tread surface between and dividing the tread lugs) in a range of from about 15 to about 22 percent.

In practice, it is envisioned that the volumetric closed cell content of the tire tread, which includes the spaced apart tread lugs, may be, for example, in a range of from about 2 to about 15, alternately from about 5 to about 10, percent based upon a volume percent of cellular voids in the total volume of the tread rubber (the tread rubber plus the cellular voids).

In practice, it is envisioned that the average size of the closed cells in the tread rubber may be, for example, in a range of from about 150 to about 350 microns.

It is to be appreciated that both the cellular volume and average closed cell size are somewhat dependent upon the selection of and amount used of the blowing agent used to form the closed cells in the tread rubber composition as well as the selection of the elastomer composition itself.

In practice, the closed cell structure in the tread is formed by an inclusion of a blowing agent in the rubber composition which liberates a gas at an elevated temperature experienced during the vulcanization of the tire assembly.

The blowing agents used in the practice of this invention are those which liberate gases upon heating, and particularly heating during the vulcanization of the rubber tire at a temperature in a range of from about 140° C. to about 160° C. Such blowing agents liberate a gas such as, for example, nitrogen, and thereby cause the formation of the closed cell structure of the tire tread. Blowing agents which liberate nitrogen are preferred. The blowing gents may be, for example, various nitro, sulfonyl and azo based materials. Representative of various blowing agents are, for example, dinitrosopentamethylene tetramine, N,N′-dimethyl-N,N′-dinitrosophthalamide, azodicarbonamide, sulfonyl hydrazides such as benzenesulfonyl hydrazide, tolunesulfonyl hydrazide and p,p′-oxybis-(benzenesulfonyl semicarbazide). In general, benzenesulfonyl hydrazide is preferred, particularly as provided as a composite of benzenesulfonyl hydrazide and paraffinic oil in a weight ratio in a range of from about 60/40 to about 75/25.

In a further aspect of the invention, a thin layer of a rubber composition as vulcanizable blend of diene-based rubber and one or more of said isobutylene-based rubbers, in a weight ratio of from 30/70 to 70/30 of such diene-based to said isobutylene-based rubbers, may be positioned between said tire tread and the underlying tire carcass.

A significant aspect of the invention is the utilization of the prescribed closed cellular structured shock absorbing isobutylene copolymer-based rubbers for the significantly raised tread lugs as being composed entirely of diene-based rubbers, as being composed of the aforesaid combination of diene-based and isobutylene copolymer based elastomers or being composed entirely of said isobutylene copolymers insofar as the rubber component of the tread rubber composition is concerned. It is preferred that the tread rubber is composed entirely of at least one of said isobutylene copolymers and particularly said brominated copolymer of isobutylene and paramethylstyrene insofar as the elastomer component of the tread rubber is concerned for significantly reduced shock absorbing ability.

In particular, the so-called shock absorbing ability of the prescribed closed cell structured spaced apart lug configured tread is largely dependent upon a damping effect of such closed cellular rubbers for shocks experienced by such raised tread lugs and, in the practice of this invention, it is preferred and is intended to be required, that the tread rubber composition, particularly for the shock-absorbing tread lugs, has a significant dampening effect.

For such raised lug configured tread of an isobutylene copolymer based rubber composition, it is to be appreciated that a minor amount of a diene based rubber may be used to enhance cured adhesion of the tread rubber to a diene-based rubber composition of the tire carcass (or tread base) which supports the circumferential tread. The butyl rubber for the closed celled tread rubber may be prepared, for example, by co-polymerizing isobutylene with a minor amount of isoprene. The halogenated butyl rubber, or halobutyl rubber, can be prepared by halogenating such butyl rubber, for example by brominating butyl rubber.

The brominated copolymer of isobutylene and paramethylstyrene for the closed cell tread rubber typically has repeat units derived from polymerization of monomers comprising at least isobutylene and paramethylstyrene. The bromine content of the copolymer rubber may be, for example, from about 0.1 to about 4 percent by weight and more desirably from about 0.1 to about 2.5 percent by weight, based upon the weight of the brominated polymer. The isobutylene content is desirably from about 85 to about 99.4, or up to about 99.8, alternately about 88 to about 97.9, weight percent. The paramethylstyrene content is usually from about 1 to about 14, alternately about 2 to about 11, weight percent. Repeat units of other monomers may also be present or may be excluded. Many such polymers are commercially available from Exxon Chemical Company as Exxpro™ and a preparation of such polymers is exemplified, for example, in U.S. Pat. No. 5,162,445 which is hereby incorporated by reference in its entirety.

A drawing is provided in order to more fully describe the invention.

In the drawing,

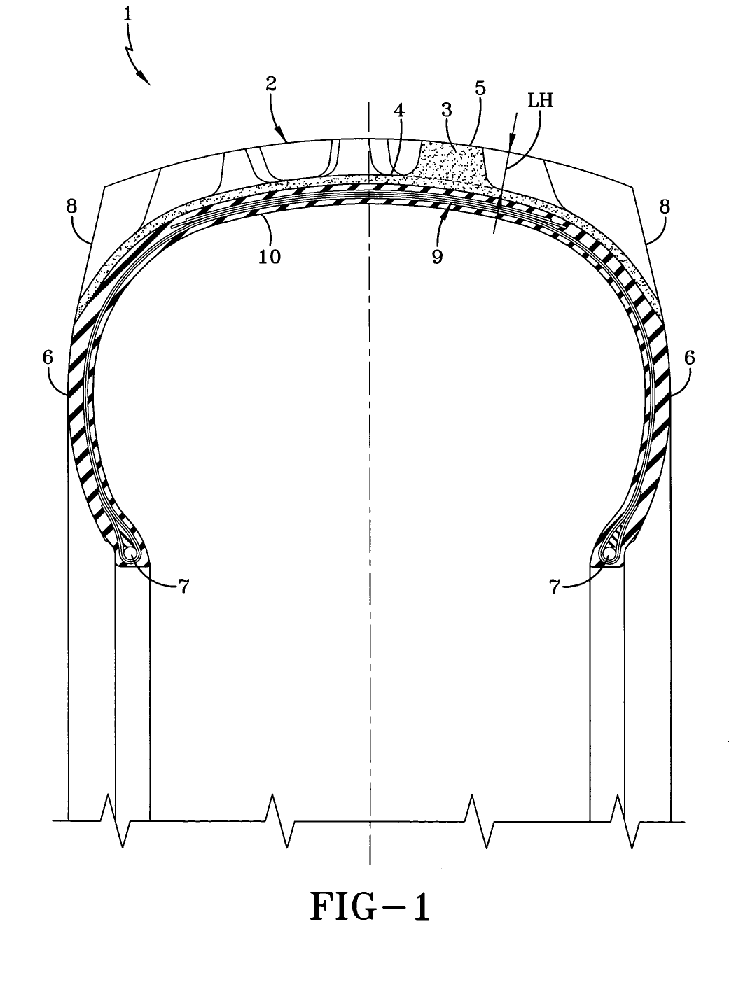

FIG. 1 is a cross-sectional view of a tire which illustrates a closed cellular rubber tread and supporting carcass as well as a sidewall rubber portion of the tire.

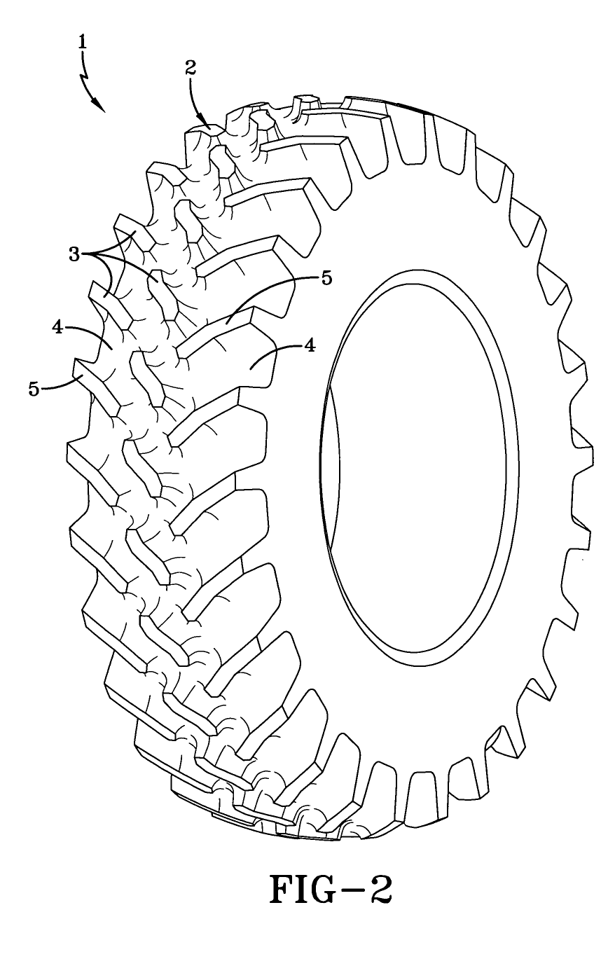

FIG. 2 is a perspective view of a tire showing spaced apart substantial tread lugs designed to be ground contacting.

In particular, a tire 1 is shown with a tread 2 configured with spaced apart substantial raised tread lugs 3 designed to be shock absorbingly ground contacting.

The raised tread lugs have a height from their base portion 4 to their surface 5 designed to be ground contacting of about 5.5 cm, or about 1.2 inches.

The tread 2 and associated tread lugs 3 are of a unitary shock-dampening closed cell structured rubber composition which comprises, based on parts by weight per 100 parts rubber (phr), of about 70 to 100 phr of brominated copolymer of isobutylene and paramethylstyrene and, correspondingly, about zero to 30 phr of sulfur curable diene-based rubber.

It is readily understood by those having skill in the art that the rubber compositions of the closed cell structured tread would be compounded with conventional compounding ingredients, together with the blowing agent, including reinforcing fillers such as carbon black and precipitated silica usually in combination with a silica coupling agent, as well as antidegradant(s), processing oil as hereinbefore defined, stearic acid or a zinc stearate, Zinc oxide, sulfur-contributing material(s) and vulcanization accelerator(s).

Such compounding of rubber is well known to those having skill in such art. Antidegradants are typically of the amine or phenolic type. While stearic acid is typically referred to as a rubber compounding ingredient, it may be pointed out that the ingredient itself is usually obtained and used as a mixture of organic acids primarily composed of stearic acid with at least one of oleic acid, linolenic acid and/or palmitic acid normally contained in the stearic acid as typically used. The mixture may contain minor amounts (less than about six weight percent) of myristic acid, arachidic acid and/or arachidonic acid. Such material or mixture is conventionally referred to in the rubber compounding art as stearic acid.

Where normal or typical rubber compounding amounts or ranges of amounts of such additives are used, they are not otherwise considered as a part of the invention. For example, some of the ingredients might be classified, in one aspect, as processing aids. Such processing aids may be, for example, waxes such as microcrystalline and paraffinic waxes typically used in a range of about 1 to 5 phr and often in a range of about 1 to about 3 phr; and resins, usually as tackifiers, such as, for example, synthetic hydrocarbon and natural resins typically used in a range of about 1 to 5 phr and often in a range of about 1 to about 3 phr. A curative might be classified as a combination of sulfur and sulfur cure accelerator(s) for the rubber compound (usually simply referred to as accelerator) or a sulfur donor/accelerator. In a sulfur and accelerator(s) curative, the amount of sulfur used is in a range of about 0.5 to about 5 phr and usually in a range of about 0.5 to about 3 phr; and the accelerator(s), often of the sulfenamide type, is (are) used in a range of about 0.5 to about 5 phr and often in a range of about 1 to about 2 phr. Alternatively, well known resin cure systems used for curing butyl rubber based rubber compositions may be used.

The ingredients, including the elastomers but exclusive of sulfur and accelerator curatives and blowing agent, are normally first mixed together in a series of at least two sequential mixing stages, although sometimes one mixing stage might be used, to a temperature in a range of about 145° C. to about 185° C., and such mixing stages are typically referred to as non-productive mixing stages. Thereafter, the sulfur and accelerators, and possibly one or more retarders and one or more antidegradants, as well as the blowing agent, are mixed therewith to a temperature of about 90° C. to about 120° C. and is typically referred as a productive mix stage. Such mixing procedure is well known to those having skill in such art.

After mixing, the compounded rubber, which contains the blowing agent, can be fabricated such as, for example, by extrusion through a suitable die to form a tire tread. The tire tread and optionally the tire sidewall is then typically built onto a sulfur curable tire carcass and the assembly thereof cured in a suitable mold under conditions of elevated temperature and pressure by methods well-known to those having skill in such art. In such case of retreading of a tire, the tire tread might first be precured and then applied to the already cured tire carcass with a curable gum strip between the tread and carcass and the assembly then submitted to curing conditions to cure the aforesaid gum strip.

The invention may be better understood by reference to the following example in which the parts and percentages are by weight unless otherwise indicated.

### EXAMPLE I

Rubber compositions envisioned as being prepared and identified herein as Samples A through C. All of the Samples contain benezenesulfonyl hydrazide in variable amounts to obtain an appropriate cellular density as hereinbefore discussed.

Sample A is composed of styrene/butadiene rubber, Sample B is composed of butyl rubber and Sample C is composed of a combination of cis 1,4-polyisoprene rubber and brominated copolymer of isobutylene and paramethylene.

Table 1 represents the prospective rubber formulations.

TABLE 1

| | Parts | | |
|---|---|---|---|
| | Control | Control | |
| Material | Sample A | Sample B | Sample C |
| Non-productive Mixing (4 minutes | | | |
| to 150° C.) | | | |
| Styrene/butadiene rubber1 | 100 | 0 | 0 |
| Cis 1,4-polyisoprene rubber² | 0 | 0 | 30 |
| Butyl rubber³ | 0 | 100 | 0 |
| Brominated copolymer4 | 0 | 0 | 70 |
| Carbon black⁵ | 50 | 50 | 50 |
| Processing oil⁶ | 5 | 5 | 5 |
| Fatty acid⁷ | 2 | 2 | 2 |
| Zinc oxide | 5 | 5 | 5 |
| Antoxidant⁸ | 2 | 2 | 2 |
| Productive Mixing (2 minutes | | | |
| to 110° C.) | | | |
| Sulfur | 1 | 1.4 | 1.5 |
| Blowing agent⁹ | variable | variable | variable |
| Accelerators¹⁰ | 1.5 | 2.5 | 1.75 |

¹Emulsion polymerization prepared styrene/butadiene rubber obtained as Plioflex ® 1502 from The Goodyear Tire & Rubber Company
²Cis 1,4-polyisoprene rubber obtained as Natsyn ® 2200 from The Goodyear Tire & Rubber Company
³Butyl rubber as a copolymer of isobutylene and a minor amount of isoprene as Butyl 268 from the Exxon Chemical Company.
⁴Brominated copolymer of isobutylene and paramethylstyrene as Exxpro ™ from the ExxonMobil Company.
⁵N299, an ASTM designation
⁶Rubber processing oil, naphthenic/paraffinic type
⁷Primarily stearic acid
⁸Of the paraphenylenediamine type
⁹Blowing agent as a blend of benzenesulfonyl hydrazide in paraffin oil in a 75/25 weight ratio as Porofor BSH ™ paste from the Mobay Synthetic Company to be used in a suitable amount to provide a desire cellular density and cell size (e.g. about 2 to about 19 phr)
¹⁰Variously, of the sulfenamide, diphenylguanidine and mercaptobenzothiazole types

The prepared rubber compositions are cured at a temperature of about 150° C. for about 36 minutes.

While certain representative embodiments and details have been shown for the purpose of illustrating the invention, it will be apparent to those skilled in this art that various changes and modifications may be made therein without departing from the spirit or scope of the invention.

1. A pneumatic rubber tire having a circumferential rubber tread configured with spaced apart raised lugs designed to be shock absorbingly ground contacting, a supporting carcass underlying said tread, a pair of spaced apart beads, and rubber sidewalls extending radially outward from said beads to the peripheral edges of said tread, wherein said raised lugs have an average height of their surface intended to be ground contacting from the base of the lugs on the tire tread in a range of about 12.5 cm to about 80 cm;
wherein said tread is a closed cellular structured rubber composition comprised of, based on parts by weight per 100 parts by weight rubber (phr):
(A) at least one diene-based elastomer, or
(B) an isobutylene copolymer based elastomer, or
(C) an elastomer composition comprised of
(1) about 75 to about 90, phr of at least one isobutylene copolymer based rubber, and
(2) about 10 to about 25, phr of at least one diene-based elastomer selected from polymers of isoprene and/or 1,3-butadiene and copolymers of styrene with isoprene and/or 1,3-butadiene;
wherein said isobutylene copolymer elastomer is selected from:
(A) butyl rubber as a copolymer of isobutylene and isoprene containing from about 0.5 to about 6 weight percent units derived from isoprene,
(B) halobutyl rubber as a halogenated butyl rubber where the halogen is selected from bromine or chlorine, preferably bromine, or
(C) brominated copolymer of isobutylene and paramethylstyrene.

2. The tire of claim 1 wherein the ratio of running surface of the tread lugs to the tread's gross dimensions is in a range of from about 15 to about 22 percent.

3. The tire of claim 1 wherein the volumetric closed cell content of the tire tread, which includes the spaced apart tread lugs is in a range of from about 2 to about 15 percent based upon a volume percent of cellular voids in the total volume of the tread rubber.

4. The tire of claim 1 wherein the average size of the closed cells in the tread rubber is a range of from about 150 to about 350 microns.

5. The tire of claim 1 wherein said blowing agent is selected from the group consisting of dinitrosopentamethylene tetramine, N,N′-dimethyl-N, N′-dinitrosophthalamide, azodicarbonamide, sulfonyl hydrazides such as benzenesulfonyl hydrazide, tolunesulfonyl hydrazide and p,p′-oxybis-(benzenesulfonyl semicarbazide).

6. The tire of claim 1 wherein said blowing agent is a composite of benzenesulfonyl hydrizide and paraffinic oil in a weight ratio in a range of from about 60/40 to about 75/25.

7. The tire of claim 1 wherein a thin layer of a rubber composition as a vulcanizable blend of diene-based rubber and one or more of said isobutylene-based rubbers, in a weight ratio of from 30/70 to 70/30 of such diene-based to said isobutylene-based rubbers, is positioned between said tread and said carcass.

8. The tire of claim 1 wherein said rubber composition is comprised of is at least one diene-based elastomer.

9. The tire of claim 1 wherein said rubber composition is comprised of a copolymer of isobutylene and isoprene.

10. The tire of claim 1 wherein said rubber composition is comprised of a diene-elastomer and a copolymer of isobutylene and isoprene.

11. The tire of claim 1 wherein said isobutylene-based rubber is a brominated copolymer of isobutylene and paramethylstyrene.

12. The tire of claim 4 wherein the volumetric closed cell content of said tire tread is in a range of from about 2 to about 15 percent based upon a volume percent of cellular voids in the total volume of the tread rubber.
